(19) United States
(12) Patent Application Publication
(10) Pub. No.: US 2015/0285390 A1
(43) Pub. Date: Oct. 8, 2015

(54) SEALING RING FOR A PRESSURE CONTROL VALVE

(71) Applicant: ElringKlinger AG, Dettingen (DE)

(72) Inventors: Guenter Grau, Bietigheim-Bissingen (DE); Martin Maier, Ingersheim (DE); Mehmet Cankar, Sulzbach (DE)

(73) Assignee: ElringKlinger AG

(21) Appl. No.: 14/741,707

(22) Filed: Jun. 17, 2015

Related U.S. Application Data
(63) Continuation of application No. PCT/EP2013/074358, filed on Nov. 21, 2013.

(30) Foreign Application Priority Data
Dec. 19, 2012 (DE) 102012112593.7

(51) Int. Cl. F16K 17/04; F16K 25/00; F16J 15/32

(52) U.S. Cl. CPC F16K 17/04; F16J 15/3212; F16J 15/3284; F16K 25/00

(57) ABSTRACT

A sealing ring for a pressure control valve for controlling boost pressure in a combustion engine with turbocharger is provided, including a sealing body which is rotationally symmetrical with regard to a cylinder axis and is made from a material which comprises as main constituent one or more perfluorinated thermoplastics, wherein the sealing body has a substantially U-shaped cross-sectional profile with an apex region and two sealing lips which, starting from the apex region, extend parallel to one another or with an opening angle at least approximately in the direction of the cylinder axis; and a spring element which is rotationally symmetrical with regard to the cylinder axis and is made of steel with a substantially U-shaped cross-sectional profile, wherein the spring element is arranged between the sealing lips of the sealing body in such a way that it bears directly against the mutually facing surfaces thereof.

### CROSS-REFERENCE TO RELATED APPLICATIONS

The present application is a continuation of international application number PCT/EP2013/074358, filed on Nov. 21, 2013, which claims priority to German patent application number 10 2012 112 593.7, filed Dec. 19, 2012, the entire specification of both being incorporated herein by reference.

### FIELD OF DISCLOSURE

The present invention relates to a sealing ring for a pressure control valve for controlling boost pressure in a combustion engine with turbocharger.

The invention furthermore relates to a pressure control valve for controlling boost pressure in a combustion engine with turbocharger, which pressure control valve comprises such a sealing ring.

### BACKGROUND

In combustion engines, in particular spark ignition engines or diesel engines in motor vehicles, which are equipped with a turbocharger for compressing the air supplied to the cylinders, boost pressure is firstly dependent on the ambient pressure of the air and on the rotational speed of the turbocharger. A pressure control valve is conventionally provided in order to enable control of boost pressure in accordance with the engine's particular power demand. Said valve comprises a valve piston which is arranged displaceably along the cylinder axis in a valve cylinder, wherein movement of the piston in the cylinder is generally effected by being subjected to an electromagnetic force, i.e., it is a solenoid valve.

In such pressure control valves, a sealing ring of a plastics material is provided to seal the valve piston relative to the valve cylinder, which sealing ring is mounted either on the cylinder or on the piston. In the former case, a dynamic seal is provided between the sealing ring and the piston (inner seal) and in the second case a dynamic seal is provided between the sealing ring and the cylinder (outer seal). If the pressure control valve is to function optimally, in particular if boost pressure is to be controlled as precisely as possible, on the one hand the sealing ring must have a very high sealing action and on the other hand there must be the least possible friction against the counter-face, such that the piston can be moved with the least possible displacement force.

In known pressure control valves according to the prior art, use is in particular made of sealing rings of elastomer materials. These materials have, however, the disadvantage that the dimensional stability of the sealing rings produced therefrom is unsatisfactory both at very low and at very high temperatures, as a result of which leaks may occur. Elastomer seals are moreover subject to relatively high material wear, which correspondingly shortens the service life thereof.

### SUMMARY OF THE INVENTION

It is therefore an object of the present invention to propose a sealing ring for a pressure control valve which permits reliable sealing over a wide temperature range while simultaneously providing low friction against the dynamic sealing face.

Said object is achieved according to the invention in the sealing ring of the type mentioned in the introduction in that the sealing ring comprises the following:
a sealing body which is rotationally symmetrical with regard to a cylinder axis and is made from a material which comprises as main constituent one or more perfluorinated thermoplastics, wherein the sealing body has a substantially U-shaped cross-sectional profile with an apex region and two sealing lips which, starting from the apex region, extend parallel to one another or with an opening angle at least approximately in the direction of the cylinder axis; and
a spring element which is rotationally symmetrical with regard to the cylinder axis and is made of steel with a substantially U-shaped cross-sectional profile, wherein the spring element is arranged between the sealing lips of the sealing body in such a way that it bears directly against the mutually facing surfaces thereof.

The sealing ring according to the invention accordingly comprises two components, wherein the first component, the actual sealing body, is formed from a material which is characterized by a high thermal and chemical resistance and a low coefficient of friction. The perfluorinated thermnoplastic(s) may here be either melt-processable or non-melt-processable, a feature which is described below in greater detail. It has been found that a sealing body made from such materials has good dimensional stability and hence a constant sealing action over a wide temperature range from around −40 to 180° C., so covering both a cold start of the engine at extremely low external temperatures and the maximum operating temperature of the pressure control valve. The materials are furthermore very resistant to the action of motor fuels or engine oil (blow-by) etc.

According to the above-described geometry of the sealing body, the two sealing lips form a groove in which the correspondingly shaped spring element made of steel is accommodated with positive engagement as the second component of the sealing ring according to the invention. In the installed situation of the sealing ring, the spring element is under radial stress and presses the two sealing lips against the respective counter-faces of the piston and cylinder of the pressure control valve, wherein the sealing body and the spring element are favorably designed and adapted to one another in such a way that the pressing of the sealing lips against the counter-faces originates substantially only from the spring element and not from an internal stress of the sealing body due to the memory effect, as is otherwise frequently the case with seals made from perfluorinated thermoplastics. In other words, the sealing body is in particular designed such that, in the absence of the spring element in the corresponding installation situation, it would have no sealing action. It has been found that, under these conditions, it is possible in the case of the sealing ring according to the invention to achieve a very low contact force of the sealing lips against the respective counter-faces which is substantially constant over a wide temperature range, such that only a slight displacement force is required to move the valve piston in the valve cylinder.

In the sealing ring according to the invention, the inner sealing lip facing the cylinder axis has an inner sealing face facing the cylinder axis and the outer sealing lip remote from the cylinder axis has an outer sealing face remote from the cylinder axis. For the purposes of the present invention, the terms “inner” and “outer” thus refer to the orientation in relation to the cylinder axis, and not for instance in relation to the groove formed between the two sealing lips.

Of the two sealing faces of the sealing body, one serves as the static sealing face and the other as the dynamic sealing face, depending on whether the sealing ring is arranged on the piston or on the cylinder of the pressure control valve. The sealing body is favorably constructed such that both the inner and the outer sealing face may alternatively serve as a dynamic sealing face, i.e., such that the same sealing ring may alternatively be used as an inner seal or as an outer seal.

The cross-sectional profile of the sealing body is favorably configured such that the inner sealing face substantially only bears against a counter-face parallel to the cylinder axis along a line which defines the inner circumference of the sealing ring. This applies in particular when the inner sealing face serves or may serve as the dynamic sealing face, wherein the counter-face is formed by the outer side of the valve piston. Friction between the sealing body and the counter-face may be minimized by such a design.

The cross-sectional profile of the sealing body is furthermore favorably configured such that the outer sealing face substantially only bears against a counter-face parallel to the cylinder axis along a line which defines the outer circumference of the sealing ring. This applies in particular when the outer sealing face serves or may serve as the dynamic sealing face, wherein the counter-face is formed by the inner side of the valve cylinder. As has already been mentioned above, it is particularly advantageous for both the inner and the outer sealing face of the sealing body to be correspondingly configured, such that the sealing ring according to the invention may be used both as an inner seal and as an outer seal.

It should be borne in mind in this connection that the predetermined geometry of the sealing body may indeed be configured such that the inner and/or outer sealing face in each case only bears against the counter-face along a line. However, under real conditions in the installation situation of the sealing ring, even the slightest material deformations result in the contact surfaces only approximately corresponding to a line, i.e., having a certain width in the direction of the cylinder axis.

The opening angle between the two sealing lips may advantageously be in the range from 0° to 30°, i.e., the two sealing lips either run parallel to one another and exactly in the direction of the cylinder axis, or they flare out starting from the apex region and extend only approximately in the direction of the cylinder axis. The opening angle is preferably in the range from 10° to 20°.

The details regarding the opening angle of the sealing lips in particular relate to the mutually facing surfaces thereof, which are favorably of planar construction, wherein the spring element bearing on these surfaces then in each case has the same opening angle. The outer contours of the sealing lips, i.e., the inner and outer sealing face, may, due to the geometry thereof, deviate from this linear course.

The bisector of the opening angle preferably runs parallel to the cylinder axis, i.e., the two sealing lips are in each case inclined by the same angle to the cylinder axis.

The typical dimensions of the sealing ring according to the invention are guided by the size of the initially described pressure control valves. The sealing body preferably has an inner diameter of 20 to 30 mm, an outer diameter of 24 to 36 mm and a height of 2.5 to 4 mm (in the direction of the cylinder axis). The height of the sealing body is determined, in the case of sealing lips of differing length, by the longer sealing lip, wherein it is preferable for the two sealing lips to have the same or a similar length.

The sealing body favorably has a material thickness of 0.15 to 0.6 mm. The material thickness of the sealing body may differ in different regions, wherein a material thickness of 0.15 to 0.3 mm is preferred in the thinnest regions.

According to the invention, the material of the sealing body comprises as main constituent one or more perfluorinated thermoplastics. According to one embodiment, this is at least one non-melt-processable perfluorinated plastic, in particular PTFE (homopolymeric tetrafluoroethylene) or modified PTFE (with a low comonomer content). While PTFE is indeed a thermoplastic, it is not melt-processable, i.e., in particular cannot be processed by injection molding, due to its extremely high melt viscosity. PTFE is distinguished by particularly high thermal and chemical resistance.

According to a further preferred embodiment of the invention, the sealing body comprises as main constituent at least one melt-processable perfluorinated thermoplastic, in particular a TFE copolymer with a comonomer content of more than 0.5 wt. %. A comonomer content of this order of magnitude is capable of reducing the molecular weight of the polymer chains without the mechanical strength of the material being impaired, such that melt viscosity is reduced and processing for example by means of injection molding is enabled. The comonomer is preferably selected from a perfluoroalkyl vinyl ether, in particular perfluoromethyl vinyl ether, hexafluoropropylene and perfluoro-(2,2-dimethyl-1,3-dioxole). Depending on the comonomer content, the perfluorinated thermoplastic is then known as a melt-processable PTFE (comonomer content up to around 3 wt. %), a PFA (more than around 3 wt. % perfluoroalkyl vinyl ether as comonomer), an MFA (more than around 3 wt. % perfluoromethyl vinyl ether as comonomer) or an FEP (more than around 3 wt. % hexafluoropropylene as comonomer).

The material of the sealing body may also comprise a mixture of various of the above-described perfluorinated thermoplastics as main constituent.

The material of the sealing body comprises the plastic(s) as main constituent, i.e., they make up more than half of the material. The material of the sealing body preferably comprises 75 wt. % or more of the at least one perfluorinated thermoplastic. The sealing body may in particular also be substantially completely formed from the at least one perfluorinated thermoplastic.

It may alternatively be provided that the material of the sealing body furthermore comprise one or more fillers, in particular pigments, friction-reducing additives and/or thermal resistance-raising additives, such as for example carbon black or molybdenum sulfide.

Depending on whether the material of the sealing body comprises a melt-processable or a non-melt-processable perfluorinated plastic, various options are available for producing the sealing ring according to the invention. According to one embodiment of the invention, the sealing ring is produced by machining the sealing body and subsequently inserting the spring element. This method is possible for all the plastics materials which may be considered, but is relatively costly.

It is therefore preferable for the sealing ring to be produced by injection-molded encapsulation of the spring element with the material of the sealing body. This manufacturing method, which is only possible when using melt-processable perfluorinated plastics, permits more efficient and thus economical manufacture of the sealing ring. Said method additionally has the advantage of an optimum interlocking connection between the sealing body and the spring element made of steel.

The invention furthermore relates to a pressure control valve for controlling boost pressure in a combustion engine with turbocharger, wherein the pressure control valve comprises a sealing ring according to the invention.

The sealing ring is mounted either on a valve cylinder or on a valve piston of the pressure control valve, wherein in the former case it is an inner seal (inner sealing face is the dynamic sealing face) and in the second case it is an outer seal (outer sealing face is the dynamic sealing face).

In the pressure control valve according to the invention, the valve piston is favorably electromagnetically movable in the valve cylinder, i.e., it is a solenoid valve.

Further advantages and preferred embodiments of the pressure control valve according to the invention have already been described in connection with the sealing ring according to the invention.

### BRIEF DESCRIPTION OF THE DRAWINGS

These and further advantages of the invention are explained in greater detail on the basis of the following exemplary embodiment with reference to the drawing, in which:

FIG. 1: is a schematic cross-sectional representation of an exemplary embodiment of a sealing ring according to the invention.

### DETAILED DESCRIPTION OF THE INVENTION

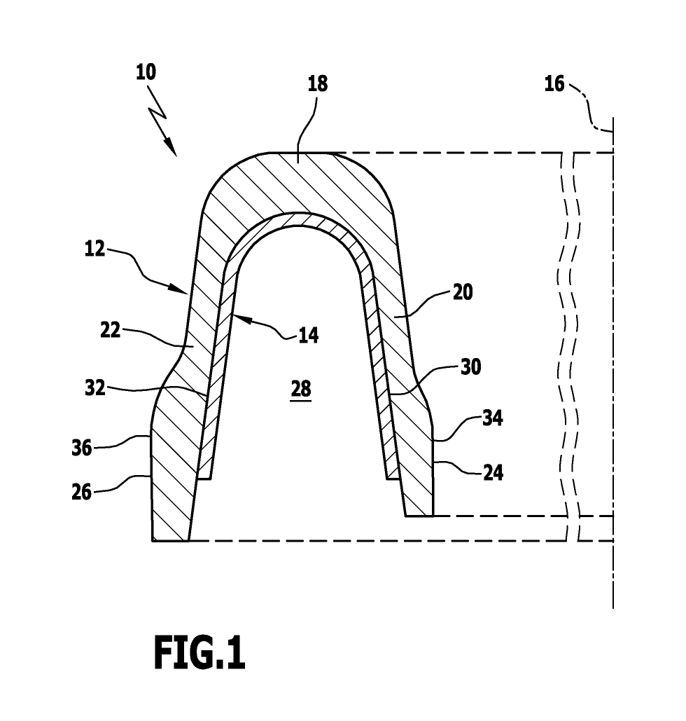

FIG. 1 shows a schematic cross-sectional representation of an exemplary embodiment of a sealing ring according to the invention which is denoted overall 10. The sealing ring 10 comprises two components, namely a sealing body 12 made from a material with one or more perfluorinated thermoplastics as main constituent and a spring element 14 made of steel, wherein both components 12 and 14 are of rotationally symmetrical construction with regard to a cylinder axis 16.

The sealing body 12 has a substantially U-shaped cross-sectional profile with an apex region 18 and two sealing lips 20 and 22 which, starting from the apex region 18, extend with an opening angle of approx. 15° approximately in the direction of the cylinder axis 16. The inner sealing lip 20 facing the cylinder axis 16 here has an inner sealing face 24 and the outer sealing lip 22 remote from the cylinder axis has an outer sealing face 26. If the sealing ring 10 in a pressure control valve is mounted on the valve cylinder, the outer sealing face 26 serves as the static sealing face and the inner sealing face 24 as a dynamic sealing face with the outer side of the valve piston as the counter-face. In the case of the sealing ring 10 being mounted on the valve piston, the opposite applies and the outer sealing face 26 then serves as the dynamic sealing face with the inner side of the valve cylinder as the counter-face. Thanks to the design of the sealing ring 10, both variants are possible.

The spring element 14 made of steel as second component of the sealing ring 10 likewise has a substantially U-shaped cross-sectional profile and is accommodated with positive engagement in the groove 28 of the sealing body 12 formed between the two sealing lips 20 and 22, such that it bears directly against the mutually facing surfaces 30 and 32 of the sealing lips 20 and 22.

The sealing body 12 and the spring element 14 are adapted to one another in such a way that, in the installed situation of the sealing ring 10, it is only the spring element 14 which biases the sealing ring 10 and applies a pressure (which is as low as possible) of the sealing lips 20 and 22 against the respective counter-faces. The cross-sectional profile of the sealing body 12 is here configured such that, ideally, both the inner sealing face 24 and the outer sealing face 26 only bear against the respective counter-face which runs parallel to the cylinder axis 16 along a line wherein, along the inner sealing face 24, said line defines the inner circumference 34 and, along the outer sealing face 26, it defines the outer circumference 36 of the sealing ring 10. As a consequence, very low friction during movement of the valve piston in the valve cylinder along the cylinder axis 16 is achieved for the respective dynamic sealing face, which in turn enables maximally precise control of boost pressure by the pressure control valve.

The sealing ring 10 shown by way of example in FIG. 1 has an inner diameter of approx. 24 mm, an outer diameter of approx. 30 mm and a height along the cylinder axis 16 of approx. 3 mm. The material thickness of the sealing body 12 amounts to approx. 0.5 mm in the apex region 18 and to approx. 0.2 mm in the thinnest regions of the sealing lips 20 and 22.

In the present exemplary embodiment, the perfluorinated thermoplastic from which the sealing body 12 is formed is a melt-processable PTFE, i.e., a TFE copolymer with a comonomer content in the range from around 0.5 to 1 wt. %, wherein the comonomer is in particular perfluoropropyl vinyl ether. The melt-processability of this material, which has thermal and chemical resistance comparable to that of homopolymeric PTFE, enables efficient and inexpensive production of the sealing ring 10 by injection-molded encapsulation of the spring element 14 with the plastics material.

The material used for the spring element 14 is a highly corrosion-resistant steel, in particular spring steel having the material number 1.4310.

The sealing ring 10 in particular excels when used as intended in a pressure control valve for controlling boost pressure in a combustion engine with turbocharger in that the sealing body 12 has high dimensional stability within a wide temperature range of around −40 to 180° C., and in that the spring element 14 enables a substantially constant, relatively slight pressing of the sealing lips 20 and 22 against the respective counter-faces with very low friction due to the perfluorinated plastics material and the ideally only linear contact of the sealing faces 24 and 26. The perfluorinated plastics material additionally has elevated chemical resistance to the effects of motor fuel and engine oil.

Tests with a sealing ring according to the above-described exemplary embodiment and a valve piston made of polyoxymethylene (POM) have revealed that a displacement force of less than 1 Newton is required for axial displacement of the piston along the inner sealing face of the sealing ring at 5 mm/min.

### LIST OF REFERENCE SIGNS

10 Sealing ring
12 Sealing body
14 Spring element
16 Cylinder axis
18 Apex region
20 Inner sealing lip
22 Outer sealing lip
24 Inner sealing face
26 Outer sealing face
28 Groove
30 Surface of 20
32 Surface of 22
34 Inner circumference of 10
36 Outer circumference of 10

1. A sealing ring in a pressure control valve for controlling boost pressure in a combustion engine with turbocharger, comprising
a sealing body which is rotationally symmetrical with regard to a cylinder axis and is made from a material which comprises as main constituent one or more perfluorinated thermoplastics, wherein the sealing body has a substantially U-shaped cross-sectional profile with an apex region and two sealing lips which, starting from the apex region, extend parallel to one another or with an opening angle at least approximately in the direction of the cylinder axis; and
a spring element which is rotationally symmetrical with regard to the cylinder axis and is made of steel with a substantially U-shaped cross-sectional profile, wherein the spring element is arranged between the sealing lips of the sealing body in such a way that it bears directly against the mutually facing surfaces thereof.

2. The sealing ring according to claim 1, wherein an inner sealing lip facing the cylinder axis has an inner sealing face facing the cylinder axis and an outer sealing lip remote from the cylinder axis has an outer sealing face remote from the cylinder axis, and wherein in an installation situation of the sealing ring one sealing face serves as a static sealing face and the other as a dynamic sealing face.

3. The sealing ring according to claim 2, wherein the cross-sectional profile of the sealing body is configured such that the inner sealing face substantially only bears against a counter-face parallel to the cylinder axis along a line which defines an inner circumference of the sealing ring.

4. The sealing ring according to claim 2, wherein the cross-sectional profile of the sealing body is configured such that the outer sealing face substantially only bears against a counter-face parallel to the cylinder axis along a line which defines an outer circumference of the sealing ring.

5. The sealing ring according to claim 1, wherein an opening angle between the two sealing lips is in the range from 0° to 30°.

6. The sealing ring according to claim 5, wherein a bisector of the opening angle runs parallel to the cylinder axis.

7. The sealing ring according to claim 1, wherein the sealing body has an inner diameter of 20 to 30 mm, an outer diameter of 24 to 36 mm, and a height of 2.5 to 4 mm.

8. The sealing ring according to claim 1, wherein the sealing body has a material thickness of 0.15 to 0.6 mm.

9. The sealing ring according to claim 1, wherein the sealing body comprises as main constituent at least one non-melt-processable perfluorinated thermoplastic, which is PTFE or modified PTFE.

10. The sealing ring according to claim 1, wherein the sealing body comprises as main constituent at least one melt-processable perfluorinated thermoplastic, which is a TFE copolymer with a comonomer content of more than 0.5 wt. %.

11. The sealing ring according to claim 10, wherein the comonomer is selected from a perfluoroalkyl vinyl ether, in particular perfluoromethyl vinyl ether, hexafluoropropylene, and perfluoro-(2,2-dimethyl-1,3-dioxole).

12. The sealing ring according to claim 10, wherein the melt-processable perfluorinated thermoplastic is a melt-processable PTFE, a PFA, an MFA or an FEP.

13. The sealing ring according to claim 1, wherein the material of the sealing body comprises 75 wt. % or more of the at least one perfluorinated thermoplastic.

14. The sealing ring according to claim 13, wherein the sealing body is substantially completely formed from the at least one perfluorinated thermoplastic.

15. The sealing ring according to claim 1, wherein the material of the sealing body furthermore comprises one or more fillers selected from pigments, friction-reducing additives, and/or thermal resistance-raising additives.

16. The sealing ring according to claim 1, wherein the sealing ring is produced by machining the sealing body and subsequently inserting the spring element.

17. The sealing ring according to claim 1, wherein the sealing ring is produced by injection-molded encapsulation of the spring element with the material of the sealing body.

18. A pressure control valve for controlling boost pressure in a combustion engine with turbocharger, wherein the pressure control valve comprises a sealing ring according to claim 1.

19. The pressure control valve according to claim 18, wherein the sealing ring is mounted on a valve cylinder or on a valve piston of the pressure control valve.

20. The pressure control valve according to claim 19, wherein the valve piston is electromagnetically movable in the valve cylinder.
